(19) United States
(12) Patent Application Publication
(10) Pub. No.: US 2021/0224024 A1
(43) Pub. Date: Jul. 22, 2021

(54) BLUETOOTH AUDIO SYSTEM WITH LOW LATENCY, AND AUDIO SOURCE AND AUDIO SINK THEREOF

(71) Applicant: Audiowise Technology Inc., Hsinchu County (TW)

(72) Inventor: Kuan-Chun CHEN, Hsinchu County (TW)

(21) Appl. No.: 17/125,074

(22) Filed: Dec. 17, 2020

Related U.S. Application Data
(60) Provisional application No. 62/963,570, filed on Jan. 21, 2020.

(51) Int. Cl. G06F 3/16; H04R 3/00

(52) U.S. Cl. CPC G06F 3/162; H04R 2420/07; H04R 3/00

(57) ABSTRACT

There is provided a Bluetooth audio system including an audio source and an audio sink. The audio sink responds multiple codec types supported thereby in a protocol message exchange of a first mode, and responds a single codec type only supported thereby and a maximum transmission unit (MTU) size as 367 bytes in a protocol message exchange of a second mode. The audio source reduces a sampling number of the used codec to be lower than 1024 samples after receiving the single codec type and the MTU size of 367 bytes.

### RELATED APPLICATIONS

The present application claims the priority benefit of U.S. Provisional Application Ser. No. 62/963,570, filed on Jan. 21, 2020, the disclosures of which are hereby incorporated by reference herein in their entirety.

### BACKGROUND

### 1. Field of the Disclosure

This disclosure generally relates to a Bluetooth application and, more particularly, to a Bluetooth audio system having low data latency and an audio source as well as an audio sink thereof.

### 2. Description of the Related Art

In the process of transmitting Bluetooth audio data from an audio source device to an audio sink device, the audio source device needs to store the audio data into the memory at first, and then the stored audio data is acquired and encoded by a codec. Finally the compressed audio data is transmitted to the audio sink device via a Bluetooth transmitter. However, the storage, acquiring and encoding of the audio data in the audio source device can cause latency in data transmission. In some scenarios, such as the channel being affected by noises, the sound quality is further degraded by the latency.

Accordingly, the present disclosure provides a Bluetooth audio system that reduces the latency of audio data caused by the signal processing process of the audio source device, and an audio source as well as an audio sink of the Bluetooth audio system.

### SUMMARY

The present disclosure provides a Bluetooth audio system that limits an audio source thereof to use only one codec to encode audio data according to the configuration parameter transmitted from an audio sink thereof in a protocol message exchange so as to reduce the latency in processing the audio data.

The present disclosure further provides a Bluetooth audio source that actively reduces a sampling number of the codec in acquiring audio data to be lower than 1024 samples according to the configuration parameter responded from an audio sink so as to reduce the latency in processing the audio data.

The present disclosure further provides a Bluetooth audio sink that responds different configuration parameters to an audio source in different modes so as to drive different operations of the audio source.

The present disclosure provides a Bluetooth audio system including an audio source and an audio sink. The audio source is configured to transmit an inquiry message in a protocol message exchange to obtain a configuration parameter. The audio sink is configured to respond multiple codec types which are supported thereby to the audio source as the configuration parameter in the protocol message exchange of a first mode, and respond a single codec type which is only supported thereby to the audio source as the configuration parameter in the protocol message exchange of a second mode.

The present disclosure further provides a Bluetooth audio source configured to receive a configuration parameter from an audio sink. When receiving multiple codec types which are supported by the audio sink from the audio sink as the configuration parameter in a first protocol message exchange, the Bluetooth audio source is configured to select one of the multiple codec types to encode audio data. When receiving a single codec type which is only supported by the audio sink from the audio sink as the configuration parameter in a second protocol message exchange, the Bluetooth audio source is configured to encode the audio data using the single codec type.

The present disclosure further provides a Bluetooth audio sink configured to respond a configuration parameter to an audio source in a protocol message exchange. The Bluetooth audio sink is configured to respond multiple codec types which are supported thereby as the configuration parameter in the protocol message exchange of a first mode. The Bluetooth audio sink is configured to respond a single codec type which is only supported thereby as the configuration parameter in the protocol message exchange of a second mode.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic block diagram of a Bluetooth audio system according to one embodiment of the present disclosure.

FIG. 2 is a schematic diagram of the protocol message exchange of a Bluetooth audio system according to one embodiment of the present disclosure.

FIG. 3 is flow chart of a protocol message exchanging method of a Bluetooth audio system according to one embodiment of the present disclosure.

### DETAILED DESCRIPTION OF THE EMBODIMENT

It should be noted that, wherever possible, the same reference numbers will be used throughout the drawings to refer to the same or like parts.

One objective of the present disclosure is to provide a Bluetooth audio system and a Bluetooth audio sink thereof that can switch into a low latency mode according to the control of a user. When a Bluetooth audio source receives a configuration parameter that indicates the Bluetooth audio sink entering a low latency mode from a normal mode, the Bluetooth audio source optionally and actively reduces a sampling number of a used codec in acquiring audio data to be lower than 1024 samples thereby reducing the total latency of processing audio data.

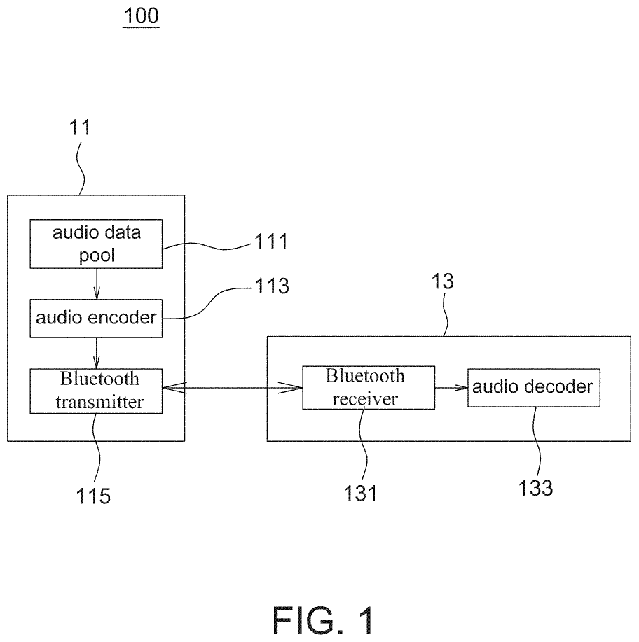

Referring to FIG. 1, it is a schematic block diagram of a Bluetooth audio system 100 according to one embodiment of the present disclosure. The Bluetooth audio system 100 includes an audio source 11 and an audio sink 13 that communicate audio data using the Bluetooth communication technology, wherein the audio source 11 is selected from, for example, a cellphone, a notebook computer, a tablet computer, a portable media player and a vehicle computer system; and the audio sink 13 is selected from, for example, a Bluetooth earphone and a Bluetooth speaker, but not limited thereto. The audio source 11 and the audio sink 13 are selected from any electronic devices that transmit or receive audio data using the Bluetooth communication technology.

The audio source 11 includes an audio data pool 111, an audio encoder 113 and a Bluetooth transmitter 115. The audio data pool 111 is used to acquire audio data from external of the audio source 11 (e.g., via internet or USB interface) or from a memory of the audio source 11. The audio encoder 113 acquires and encodes the audio data in the audio data pool 111 using one of multiple codecs, wherein the multiple codecs support, for example, a sub-band coding (SBC), an advanced audio coding (AAC), an LDAC (an audio coding technology developed by Sony), a vendor defined coding or other conventional coding, to performing the data encoding. The Bluetooth transmitter 115 then selects a packet type from multiple packet types to transmit the compressed audio data to the audio sink 13.

It should be mentioned that although FIG. 1 shows the operation of the audio source 11 using multiple functional blocks (including 111, 113 and 115), the operations of these functional blocks are all considered to be performed by the audio source 11. For example, the audio source 11 includes software and/or hardware to perform the functions of the audio data pool 111 and the audio encoder 113, and includes an application specific integrated circuit (ASIC) to perform the operation of the Bluetooth transmitter 115, but the present disclosure is not limited thereto.

The audio sink 13 includes a Bluetooth receiver 131 and an audio decoder 133. The Bluetooth receiver 131 is used to receive audio data from the audio transmitter 115. The audio decoder 133 is used to decode the received audio data using a corresponding codec (corresponding to 113), and the decoded audio data is transmitted to an output device (e.g., a speaker, not shown herein) to be played thereby.

Similarly, although FIG. 1 shows the operation of the audio sink 13 using multiple functional blocks (including 131 and 133), the operations of these functional blocks are all considered to be performed by the audio sink 13. For example, the audio sink 13 includes software and/or hardware to perform the function of the audio decoder 133, and includes an ASIC to perform the operation of the Bluetooth receiver 131, but the present disclosure is not limited thereto.

The operations of the Bluetooth transmitter 115 and the Bluetooth receiver 131 are known to the art and are not main objectives of the present disclosure, and thus details thereof are not described herein.

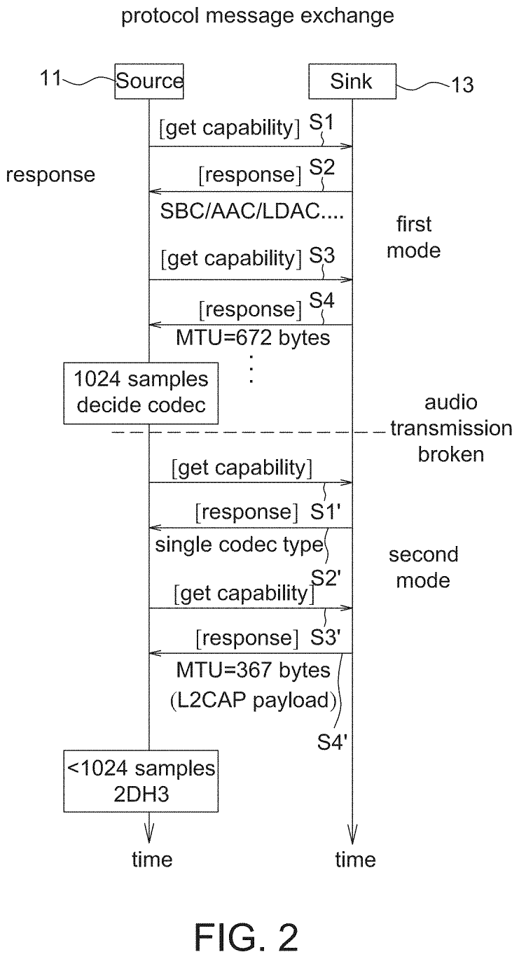

Please referring to FIG. 2, it is a schematic diagram of the protocol message exchange of a Bluetooth audio system 100 according to one embodiment of the present disclosure. The audio data transmission after the protocol message exchange is known to the art and not a main objective of the present disclosure, and thus details thereof are not described herein. One objective of the present disclosure is to cause the audio source 11 to know, through the protocol message exchange, a current operation mode of the audio sink 13 and to perform a corresponding operation.

In the present disclosure, the audio source 11 is used to send, in a protocol message exchange, an inquiry message (e.g., shown as [get capability] message) in order to obtain a configuration parameter from the audio sink 13, wherein the configuration parameter includes, for example, the Logic Link Control and Adaptation Protocol (L2CAP) Maximum Transmission Unit (MTU) and the codec type supported by the audio sink 13. A size of L2CAP MTU is obtained using a proper protocol, e.g., Audio/Video Data Transport Protocol (AVDTP) or service discovery protocol (SDP), but not limited thereto.

In the present disclosure, the audio sink 13 is switched between a first mode and a second mode according to the control of a user. In one aspect, the first mode is a normal mode, and the second mode is a low latency mode. The first mode and the second mode are switched therebetween by a button or a switch arranged on or a knock(s) (e.g., including a G-sensor for detecting the knock of a user) knocked on a case of the audio sink 13 or by running a predetermined APP application operated (e.g., through clicking on an icon or voice control) by the user.

In the first mode, the audio source 11 freely determines a codec type and a transmission packet type from multiple choices, and a sampling number of a used codec in acquiring audio data is set as 1024 samples, i.e. encoding every 1024 samples. In the second mode, the audio source 11 is limited or triggered by the configuration parameter sent from the audio sink 13 to passively determine a particular codec type and a particular transmission packet type, and the sampling number of the used codec in acquiring audio data is decreased, i.e. each encoding using lower than 1024 samples.

It should be mentioned that although FIG. 2 shows that the Bluetooth audio system 100 of the present disclosure is operated in a first mode or a second mode, the audio source 11 is actually responded to the mode switching of the audio sink 13 to change the codec type, transmission packet type and codec sampling number. In the protocol message exchange of the first and second modes, the inquiry messages sent by the audio source 11 are identical. That is, the processes S1 and S1′ are identical to each other in order to inquire the codec type supported by the audio sink 13; and the processes S3 and S3′ are identical to each other in order to inquire the MTU size supported by the audio sink 13.

### First Mode (First Protocol Message Exchange)

Firstly, the audio source 11 transmits a [get capability] message (as an inquiry message) to the audio sink 13 in a protocol message exchange to confirm the codec type (process S1); and next, after receiving the inquiry message, the audio sink 13 replies a [response] message, which includes multiple codec types supported thereby, in the protocol message exchange to the audio source 11 as the configuration parameter (process S2), wherein FIG. 2 shows the multiple codec types supporting SBC, AAC and LDAC, but not limited thereto.

The audio source 11 further transmits another [get capability] message (as another inquiry message) to the audio sink 13 in the protocol message exchange to confirm the L2CAP MTU size (process S3); and next, after receiving the another inquiry message, the audio sink 13 replies a [response] message, which includes the L2CAP MTU size supported thereby such as 672 bytes or 1017 bytes, using AVDTP in the protocol message exchange to the audio source 11 as the configuration parameter (process S4).

In another aspect, the processes S3 and D4 are performed at first and then the processes S1 and S2 are then performed.

After receiving the configuration parameter in the protocol message exchange, the audio source 11 selects one of multiple codec types supported by the audio sink 13 to encode audio data in the audio data transmission (i.e. after the first protocol message exchange accomplished) and the used codec uses a sampling number of 1024 samples (or data) in encoding audio data in the audio data pool 111.

Meanwhile, the audio source 11 further determines a packet type in transmitting the audio data, e.g., selected from EDR2M or EDR3M.

When the audio sink 13 is going to be switched from the first mode to a second mode, the audio transmission is broken off or stopped at first and the configuration parameter is confirmed through another protocol message exchange.

### Second Mode (Second Protocol Message Exchange)

Similarly, the audio source 11 transmits a [get capability] message (as an inquiry message) to the audio sink 13 in a protocol message exchange to confirm the codec type (process S1′); and next, after receiving the inquiry message, the audio sink 13 replies a [response] message, which includes a single codec type only supported thereby, in the protocol message exchange to the audio source 11 as the configuration parameter (process S2′), wherein the single codec type is one of the multiple codec types in the process S2, e.g., SBC, but not limited thereto. In another aspect, the single codec type is not included in the multiple codec types of the first mode.

Similarly, the audio source 11 further transmits another [get capability] message (as another inquiry message) to the audio sink 13 in the protocol message exchange to confirm the L2CAP MTU size (process S3′); and next, after receiving the another inquiry message, the audio sink 13 replies a [response] message, which includes the L2CAP MTU size supported thereby such as 367 bytes, using AVDTP in the protocol message exchange to the audio source 11 as the configuration parameter (process S4′).

That, in the second protocol message exchange, the audio source 11 receives the configuration parameter which includes a limited single codec type and a L2CAP MTU size of 367 bytes.

Similarly, in another aspect, the processes S3′ and D4′ are performed prior to the processes S1′ and S2′ are then performed.

After receiving the configuration parameter of the same audio sink 13 in the second protocol message exchange, the audio source 11 encodes audio data using said single codec type in transmitting the audio data in the second mode.

In one aspect, the audio source 11 further adopts the 2DH3 packet type of AVDPT for transmitting audio data in the second mode to reduce the transmission latency of audio data.

In one aspect, the audio source 11 further actively reduces a sampling number of the used codec in acquiring audio data in the audio data pool 111 to be lower than 1024 samples to reduce the latency of processing audio data in the second mode, wherein the sampling number is selected as, for example, 128, 384, 768 samples (or data), but not limited thereto.

For example, if 1024 samples (or data) are acquired by 48 KHz sampling rate, 21 ms (millisecond) is required for one encoding; whereas if 768 samples (or data) are acquired by 48 KHz sampling rate, only 16 ms is required for one encoding such that the latency of processing audio data is effectively decrease.

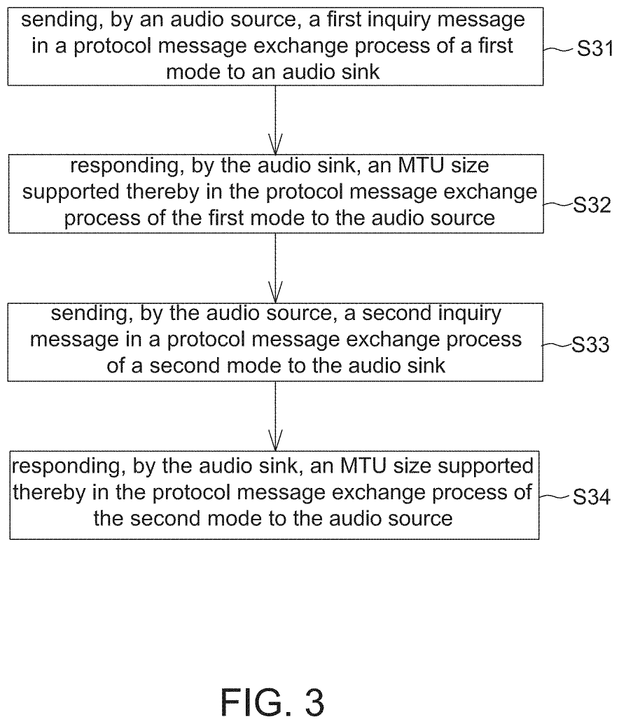

Please referring to FIG. 3, it is a flow chart of a protocol message exchanging method of a Bluetooth audio system according to one embodiment of the present disclosure, which is adapted to the Bluetooth audio system 100 in FIG. 1. The protocol message exchanging method includes the steps of: sending, by an audio source 11, a first inquiry message (e.g., in S1) in a protocol message exchange process of a first mode to an audio sink 13 (Step S31); responding, by the audio sink 13, multiple codec types supported thereby (e.g., in S2) in the protocol message exchange process of the first mode to the audio source 11 (Step S32); sending, by the audio source 11, a second inquiry message (e.g., in S1′) in a protocol message exchange process of a second mode to the audio sink 13 (Step S33); and responding, by the audio sink 13, a single codec type only supported thereby (e.g., in S2′) in the protocol message exchange process of the second mode to the audio source 11 (Step S34).

In addition, the protocol message exchanging method of the present disclosure further includes the steps of: sending, by an audio source 11, a first inquiry message (e.g., in S3) in a protocol message exchange process of a first mode to an audio sink 13; responding, by the audio sink 13, an MTU size (shown as 672 bytes, but not limited to) supported thereby (e.g., in S4) in the protocol message exchange process of the first mode to the audio source 11; sending, by the audio source 11, a second inquiry message (e.g., in S3′) in a protocol message exchange process of a second mode to the audio sink 13; and responding, by the audio sink 13, an MTU size (shown as 367 bytes, but not limited to) supported thereby (e.g., in S4′) in the protocol message exchange process of the second mode to the audio source 11.

The protocol message exchanging method in FIG. 3 has been described in FIG. 2 and the corresponding descriptions thereof, and thus details thereof are not repeated herein.

When the protocol message exchange process is over, the audio source 11 performs the acquiring, encoding and transmission of audio data according to the configuration parameter obtained in the protocol message exchange process of the first mode or the second mode.

As mentioned above, because in the process of storing, acquiring and encoding audio data by an audio source can cause the latency in data transmission that further degrades the sound quality. Therefore, the present disclosure further provides a Bluetooth audio system that can switch into a low latency mode and an audio source as well as an audio sink thereof (referring to FIG. 1) in which the audio sink replies a configuration parameter that indicates the low latency mode is entered to drive or trigger the audio source to use a predetermined single codec type and to actively reduce a sampling number of a codec in compressing audio data to be lower than 1024 samples (or data) so as to reduce the total latency of transmitting the audio data.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A Bluetooth audio system, comprising:
an audio source configured to transmit an inquiry message in a protocol message exchange to obtain a configuration parameter; and
an audio sink, configured to
respond multiple codec types which are supported thereby to the audio source as the configuration parameter in the protocol message exchange of a first mode, and
respond a single codec type which is only supported thereby to the audio source as the configuration parameter in the protocol message exchange of a second mode.

2. The Bluetooth audio system as claimed in claim 1, wherein the single codec type is one of the multiple codec types or is not included in the multiple codec types.

3. The Bluetooth audio system as claimed in claim 1, wherein
the single codec type supports a sub-band coding, and
the multiple codec types support the sub-band coding, an advanced audio coding, an LDAC and a vendor defined coding.

4. The Bluetooth audio system as claimed in claim 1, wherein the first mode and the second mode are switched according to a button, a switch or a knock of the audio sink.

5. The Bluetooth audio system as claimed in claim 1, wherein the audio sink is further configured to
use an Audio/Video Data Transport Protocol (AVDTP) to respond a Logic Link Control and Adaptation Protocol (L2CAP) Maximum Transmission Unit (MTU) size as 672 bytes or 1071 bytes to the audio source as the configuration parameter in the protocol message exchange of the first mode, and
use the AVDTP to respond the L2CAP MTU size as 367 bytes to the audio source as the configuration parameter in the protocol message exchange of the second mode.

6. The Bluetooth audio system as claimed in claim 5, wherein the audio source is further configured to adopt a 2DH3 packet type of AVDTP to transmit audio data in the second mode.

7. The Bluetooth audio system as claimed in claim 5, wherein the audio source is further configured to actively reduce a sampling number of a used codec in acquiring audio data to be lower than 1024 samples thereby reducing latency of processing the audio data in the second mode.

8. The Bluetooth audio system as claimed in claim 1, wherein
the audio source is a cellphone, a notebook computer, a tablet computer, a portable media player or a vehicle computer system, and
the audio sink is a Bluetooth earphone or a Bluetooth speaker.

9. A Bluetooth audio source, configured to receive a configuration parameter from an audio sink, wherein
when receiving multiple codec types which are supported by the audio sink from the audio sink as the configuration parameter in a first protocol message exchange, the Bluetooth audio source is configured to select one of the multiple codec types to encode audio data, and
when receiving a single codec type which is only supported by the audio sink from the audio sink as the configuration parameter in a second protocol message exchange, the Bluetooth audio source is configured to encode the audio data using the single codec type.

10. The Bluetooth audio source as claimed in claim 9, wherein the single codec type is one of the multiple codec types or is not included in the multiple codec types.

11. The Bluetooth audio source as claimed in claim 9, wherein
the single codec type supports a sub-band coding, and
the multiple codec types support the sub-band coding, an advanced audio coding, an LDAC and a vendor defined coding.

12. The Bluetooth audio source as claimed in claim 9, wherein the Bluetooth audio source is a cellphone, a notebook computer, a tablet computer, a portable media player or a vehicle computer system.

13. The Bluetooth audio source as claimed in claim 9, wherein the Bluetooth audio source is further configured to use an AVDTP to receive a L2CAP MTU size as 367 bytes from the audio sink as the configuration parameter in the second protocol message exchange.

14. The Bluetooth audio source as claimed in claim 13, wherein the Bluetooth audio source is further configured to adopt a 2DH3 packet type of AVDTP to transmit audio data after the second protocol message exchange.

15. The Bluetooth audio source as claimed in claim 13, wherein the Bluetooth audio source is further configured to actively reduce a sampling number of a used codec in acquiring audio data to be lower than 1024 samples after the second protocol message exchange thereby reducing latency of processing the audio data.

16. A Bluetooth audio sink configured to respond a configuration parameter to an audio source in a protocol message exchange, wherein
the Bluetooth audio sink is configured to respond multiple codec types which are supported thereby as the configuration parameter in the protocol message exchange of a first mode, and
the Bluetooth audio sink is configured to respond a single codec type which is only supported thereby as the configuration parameter in the protocol message exchange of a second mode.

17. The Bluetooth audio sink as claimed in claim 16, wherein the single codec type is one of the multiple codec types or is not included in the multiple codec types.

18. The Bluetooth audio sink as claimed in claim 16, further comprising:
the single codec type supports a sub-band coding, and
the multiple codec types support the sub-band coding, an advanced audio coding, an LDAC and a vendor defined coding.

19. The Bluetooth audio sink as claimed in claim 16, wherein the Bluetooth audio sink is further configured to
use an AVDTP to respond a L2CAP MTU size as 367 bytes to the audio source as the configuration parameter in the protocol message exchange of the second mode.

20. The Bluetooth audio sink as claimed in claim 16, wherein the Bluetooth audio sink is further configured to
actively reduce a sampling number of a used codec in acquiring audio data to be lower than 1024 samples thereby reducing latency of processing the audio data in the second mode.
